(19) United States
(12) Patent Application Publication
(10) Pub. No.: US 2023/0253868 A1
(43) Pub. Date: Aug. 10, 2023

(54) FAST RESPONSE LINEAR VIBRATION MOTOR STRUCTURE AND IMPLEMENTATION METHOD THEREFOR

(71) Applicant: ZHEJIANG DONGYANG DONGCI CHENGJI ELECTRONICS CO. , LTD., Dongyang Jinhua, Zhejiang (CN)

(72) Inventors: Xinjiang YAN, Dongyang (CN); Yangdong ZHOU, Dongyang (CN)

(73) Assignee: ZHEJIANG DONGYANG DONGCI CHENGJI ELECTRONICS CO. , LTD., Dongyang Jinhua, Zhejiang (CN)

(21) Appl. No.: 18/003,320

(22) PCT Filed: Jun. 11, 2021
(86) PCT No.: PCT/CN2021/099633

§ 371 Date: Dec. 26, 2022

(30) Foreign Application Priority Data
Jun. 24, 2020 (CN) 202010583956.4

(51) Int. Cl. H02K 33/18

(52) U.S. Cl. CPC H02K 33/18

(57) ABSTRACT

Disclosed is a fast response linear vibration motor structure, comprising a lower bracket; an FPC is connected above the lower bracket, a stator assembly is disposed above the FPC, an outer sleeve of the stator assembly is provided with a vibrator assembly, an outer sleeve of the vibrator assembly is provided with a housing, the housing is connected above the lower bracket, the vibrator assembly is connected to the housing by means of elastic pieces, two sets of coils are wound on a core, and the coils are electrically connected to the FPC. The vibrator assembly comprises a magnetic steel group and a second mass block, wherein the magnetic steel group is embedded inside of the second mass block. Further disclosed is an implementation method for a fast response linear vibration motor structure. According to the invention, two groups of coils are provided, and the two groups of coils cooperate with the core after being powered on and can generate stronger magnetic fields, so that the driving force of the motor is increased, and the vibration sensations of the motor are increased. According to the invention, four magnetic steel pieces are provided, so that the strength of the magnetic field generated by the magnetic steel is increased to then increase the driving force of the motor, and increase the vibration sensations of the motor.

### FIELD OF THE INVENTION

The present disclosure belongs to the technical field of vibration motors, and particularly to a fast response linear vibration motor structure and an implementation method therefor.

### BACKGROUND OF THE INVENTION

A miniature vibration motor is an indispensable component of an electronic product such as a mobile phone, a tablet computer, and an electronic toy, which provides a tactile feedback for a user. With the intensification of competition in the smartphone market, mobile phone manufacturers have paid more and more attention to tactile experiences of users. At present, a mobile consumer electronic product in the market generally uses a vibration motor as a system feedback component, such as incoming call notification of a mobile phone and vibration feedback of a game console. In a vibration motor related patent, a driving force is generally provided for a motor only by interaction of a coil and magnetic steel, so as to drive the motor to reciprocate. However, the motor driving force in this driving mode is relatively weak, resulting in slow response of the motor. Therefore, it is necessary to design a fast response linear vibration motor. This patent provides a fast response linear vibration motor structure that is simple, convenient to manufacture, and fast in response.

### SUMMARY OF THE INVENTION

An objective of the present disclosure is to provide a fast response linear vibration motor structure, so as to solve the problems presented in Background of the Invention. The fast response linear vibration motor structure provided in the present disclosure has the characteristics of simple structure, convenience for manufacturing, and fast response.

Another objective of the present disclosure is to provide an implementation method for a fast response linear vibration motor structure.

In order to achieve the above objective, the present disclosure provides the following technical solution: a fast response linear vibration motor structure including a lower bracket. A Flexible Printed Circuit (FPC) is connected above the lower bracket. A stator assembly is arranged above the FPC. The stator assembly is sheathed with a vibrator assembly. The vibrator assembly is sheathed with a casing. The casing is connected above the lower bracket. The vibrator assembly is connected to the casing by leaf springs. The stator assembly includes a core. Two sets of coils are wound on the core. The coils are electrically connected to the FPC. The vibrator assembly includes a steel magnet group and a second mass block, and the steel magnet group is embedded into the second mass block.

Further, in the present disclosure, the steel magnet group includes four steel magnets, and the four steel magnets are arranged side by side in pairs on two sides of a long edge in the second mass block.

Further, in the present disclosure, the vibrator assembly further includes two first mass blocks, and the two first mass blocks are located above two sides of a long edge in the second mass block.

Further, in the present disclosure, a gasket is connected above the second mass block.

Further, in the present disclosure, foams are connected to two sides of a short edge in the second mass block.

Further, in the present disclosure, stop pieces are connected to each of two opposite sides of a connecting arm of the leaf spring.

Further, in the present disclosure, the core is a magnetic conduction component.

Further, in the present disclosure, a cavity configured to accommodate the stator assembly is formed in the second mass block.

Further, in the present disclosure, an implementation method for the fast response linear vibration motor structure includes the following steps:

(1) forming a closed accommodation cavity by a casing (1) and a lower bracket (9) to accommodate a vibrator assembly and stator assembly inside;

(2) the vibrator assembly comprising a second mass block (5), a steel magnet group, and first mass blocks (3), wherein the steel magnet group provides a magnetic field to drive a motor;

(3) the stator assembly comprising coils (7), an FPC (8), and a core (10), and the coils (7) and the FPC (8) form a circuit to generate a magnetic field by energizing to drive the motor to vibrate by interaction of the magnetic field by energizing and the permanent magnetic field generated by the steel magnet group; and

(4) connecting the casing (1) to the vibrator assembly by leaf springs (6) to provide elasticity for motion such that the vibrator assembly reciprocates.

Further, in the present disclosure, in the method for implementing the fast response linear vibration motor structure, the steel magnet group includes four steel magnets, and the four steel magnets are arranged side by side in pairs on two sides of a long edge in the second mass block. The vibrator assembly further includes two first mass blocks, and the two first mass blocks are located above two sides of a long edge in the second mass block. A gasket is connected above the second mass block. Foams are connected to two sides of a short edge in the second mass block. Stop pieces are connected to each of two opposite sides of a connecting arm of the leaf spring. The core is a magnetic conduction component. A cavity configured to accommodate the stator assembly is formed in the second mass block.

Compared with the prior art, the present disclosure has the following beneficial effects.

1: In the present disclosure, there are arranged the two groups of coils that may be matched with the core after energized to generate a stronger magnetic field, so that a driving force and vibration level of the motor are increased.

2: In the present disclosure, there are arranged the four steel magnets, so that the intensity of the magnetic field generated by the steel magnets is increased, increasing the driving force and vibration level of the motor.

3: In the present disclosure, the first mass blocks are additionally arranged based on the second mass block, so that the overall weight of mass blocks is increased, and then the vibration level of the motor during vibration can be increased.

4: In the present disclosure, the core is made of ferrite stainless steel, and in case of de-energizing, the motor is endowed with an electromagnetic damping effect by an eddy effect of the core, so that the motor can response faster to stop faster.

5: In the present disclosure, the foams are adhered to the two sides of the short edge in the second mass block by glue, so as to limit the displacement of the motor during motion to prevent a product from producing a noise by hard collision.

### BRIEF DESCRIPTION OF THE DRAWINGS

FIG. 1 is a schematic exploded structural diagram according to the present disclosure;

FIGS. 2 and 3 are schematic sectional structural diagrams according to the present disclosure; and

FIG. 4 is a schematic diagram of an electromagnetic driving structure according to the present disclosure.

In the drawings: 1—casing; 2—gasket; 3—first mass block; 4—steel magnet; 5—second mass block; 6—leaf spring; 61—stop piece; 7—coil; 8—FPC; 9—lower bracket; 10—core; and 11—foam.

### DETAILED DESCRIPTION OF THE EMBODIMENTS

The technical solutions in embodiments of the present disclosure will be described clearly and completely below in combination with the drawings in the embodiments of the present disclosure. Clearly, the described embodiments are not all but only part of embodiments of the present disclosure. All other embodiments obtained by those of ordinary skill in the art based on the embodiments in the present disclosure without creative work shall fall within the scope of protection of the present disclosure.

### Embodiment 1

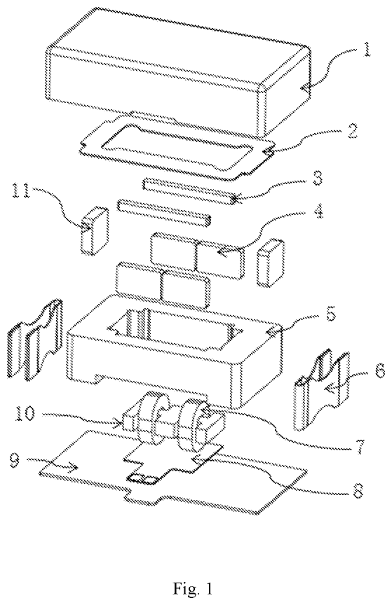

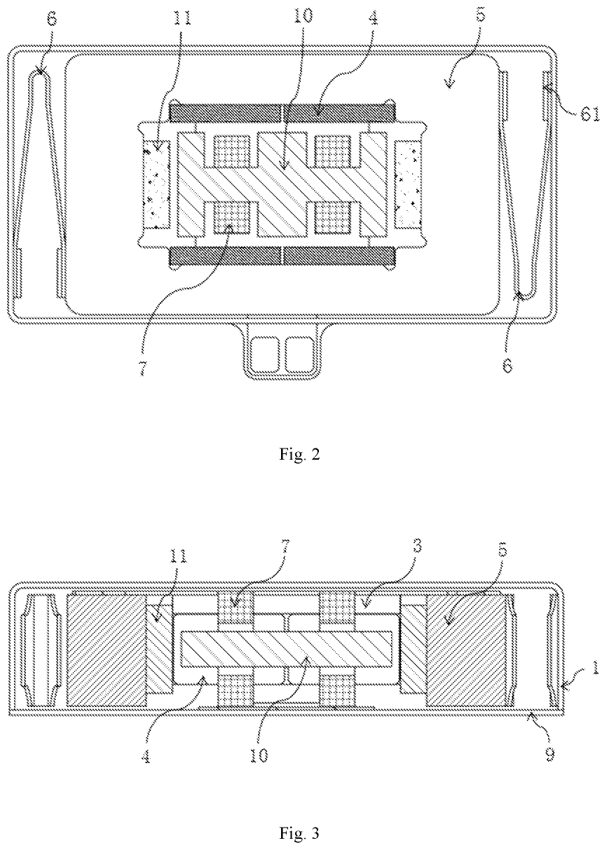

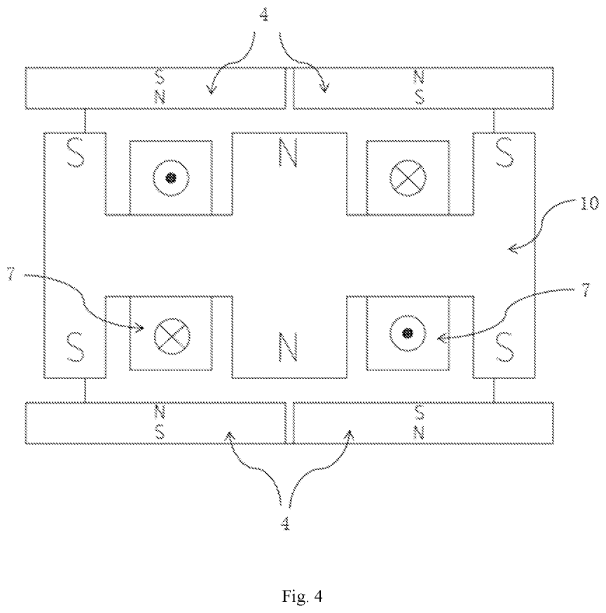

Referring to FIGS. 1 to 4, the present disclosure provides the following technical solution: a fast response linear vibration motor structure including a lower bracket 9. An FPC 8 is connected above the lower bracket 9. A stator assembly is arranged above the FPC 8. The stator assembly is sheathed with a vibrator assembly. The vibrator assembly is sheathed with a casing 1. The casing 1 is connected above the lower bracket 9. The vibrator assembly is connected to the casing 1 by leaf springs 6. The stator assembly includes a core 10. Two sets of coils 7 are wound on the core 10. The coils 7 are electrically connected to the FPC 8. The vibrator assembly includes a steel magnet group and a second mass block 5, and the steel magnet group is embedded into the second mass block 5.

Further, the steel magnet group includes four steel magnets 4, and the four steel magnets 4 are adhered to two sides of a long edge in the second mass block 5 side by side in pairs by glue.

With adoption of the above technical solution, the steel magnets 4 provide a magnetic field to drive the motor.

Further, stop pieces 61 are connected to each of two opposite sides of connecting arms of the leaf springs 6.

Further, the core 10 is a magnetic conduction component. In the present embodiment, the core 10 is made of ferrite stainless steel.

Further, a cavity configured to accommodate the stator assembly is formed in the second mass block 5.

### Embodiment 2

The present embodiment differs from embodiment 1 as follows: further, the vibrator assembly further includes two first mass blocks 3, and the two first mass blocks 3 are located above two sides of a long edge in the second mass block 5.

With adoption of the above technical solution, the weight of mass blocks is increased by the two first mass blocks 3, so as to ensure a higher vibration level of the motor.

Further, a gasket 2 is welded above the second mass block 5 by laser.

With adoption of the above technical solution, the gasket 2 serves as a supporting surface for assembling the first mass blocks 3.

### Embodiment 3

The present embodiment differs from embodiment 1 as follows: further, foams 11 are adhered to two sides of a short edge in the second mass block (5) by glue.

With adoption of the above technical solution, the displacement of the motor during motion is limited by the foams 11 to prevent a product from producing a noise by hard collision.

Further, an implementation method for the fast response linear vibration motor structure in the present disclosure includes the following steps.

(1) A casing 1 and a lower bracket 9 form a closed accommodation cavity to accommodate a vibrator assembly and stator assembly inside.

(2) The vibrator assembly includes a second mass block 5, a steel magnet group, and first mass blocks 3, and the steel magnet group provides a magnetic field to drive a motor.

(3) The stator assembly includes coils 7, an FPC 8, and a core 10, and the coils 7 and the FPC 8 form a circuit to generate a magnetic field by energizing to drive the motor to vibrate by interaction of the magnetic field by energizing and the permanent magnetic field generated by the steel magnet group.

(4) The casing 1 is connected to the vibrator assembly by leaf springs 6 to provide elasticity for motion such that the vibrator assembly reciprocates horizontally.

In summary, in the present disclosure, there are arranged the two groups of coils 7 that may be matched with the core after energized to generate a stronger magnetic field, so that a driving force and vibration level of the motor are increased. In the present disclosure, there are arranged the four steel magnets 4, so that the intensity of the magnetic field generated by the steel magnets 4 is increased, increasing the driving force and vibration level of the motor. In the present disclosure, the first mass blocks 3 are additionally arranged based on the second mass block 5, so that the overall weight of mass blocks is increased, and then the vibration level of the motor during vibration can be increased. In the present disclosure, the core 10 is made of ferrite stainless steel, and in case of de-energizing, the motor is endowed with an electromagnetic damping effect by an eddy effect of the core 10, so that the motor can response faster to stop faster. In the present disclosure, the foams 11 are adhered to the two sides of the short edge in the second mass block 5 by glue, so as to limit the displacement of the motor during motion to prevent a product from producing a noise by hard collision.

Although the embodiments of the present disclosure have been shown and described, it can be understood by those of ordinary skill in the art that various variations, modifications, replacements, and transformations may be made to these embodiments without departing from the principle and spirit of the present disclosure. The scope of the present disclosure is defined by the appended claims and equivalents thereof.

1. A fast response linear vibration motor structure, comprising a lower bracket (9), wherein a Flexible Printed Circuit (8) is connected above the lower bracket (9); a stator assembly is arranged above the FPC (8); the stator assembly is sheathed with a vibrator assembly; the vibrator assembly is sheathed with a casing (1); the casing (1) is connected above the lower bracket (9); the vibrator assembly is connected to the casing (1) by leaf springs (6); the stator assembly comprises a core (10); two sets of coils (7) are wound on the core (10); the coils (7) are electrically connected to the FPC (8); and the vibrator assembly comprises a steel magnet group and a second mass block (5), and the steel magnet group is embedded into the second mass block (5).

2. The fast response linear vibration motor structure according to claim 1, wherein the steel magnet group comprises four steel magnets (4), and the four steel magnets (4) are arranged side by side in pairs on two sides of a long edge in the second mass block (5).

3. The fast response linear vibration motor structure according to claim 1, wherein the vibrator assembly further comprises two first mass blocks (3), and the two first mass blocks (3) are located above two sides of a long edge in the second mass block (5).

4. The fast response linear vibration motor structure according to claim 1, wherein a gasket (2) is connected above the second mass block (5).

5. The fast response linear vibration motor structure according to claim 1, wherein foams (11) are connected to two sides of a short edge in the second mass block (5).

6. The fast response linear vibration motor structure according to claim 1, wherein stop pieces (61) are connected to each of two opposite sides of connecting arms of the leaf springs (6).

7. The fast response linear vibration motor structure according to claim 1, wherein the core (10) is a magnetic conduction component.

8. The fast response linear vibration motor structure according to claim 1, wherein a cavity configured to accommodate the stator assembly is formed in the second mass block (5).

9. An implementation method for the fast response linear vibration motor structure according to claim 1, the method comprising the following steps:
(1) forming a closed accommodation cavity by a casing (1) and a lower bracket (9) to accommodate a vibrator assembly and stator assembly inside;
the vibrator assembly comprising a second mass block (5), a steel magnet group, and first mass blocks (3), wherein the steel magnet group provides a magnetic field to drive a motor;
(3) the stator assembly comprising coils (7), an FPC (8), and a core (10), and the coils (7) and the FPC (8) form a circuit to generate a magnetic field by energizing to drive the motor to vibrate by interaction of the magnetic field by energizing and the permanent magnetic field generated by the steel magnet group; and
(4) connecting the casing (1) to the vibrator assembly by leaf springs (6) to provide elasticity for motion such that the vibrator assembly reciprocates.

10. The method for implementing the fast response linear vibration motor structure according to claim 9, wherein the steel magnet group comprises four steel magnets (4), and the four steel magnets (4) are arranged side by side in pairs on two sides of a long edge in the second mass block (5); the vibrator assembly further comprises two first mass blocks (3), and the two first mass blocks (3) are located above two sides of the long edge in the second mass block (5); a gasket (2) is connected above the second mass block (5); foams (11) are connected to two sides of a short edge in the second mass block (5); stop pieces (61) are connected to each of two opposite sides of connecting arms of the leaf springs (6); the core (10) is a magnetic conduction component; and a cavity configured to accommodate the stator assembly is formed in the second mass block (5).
